(19) United States
(12) Patent Application Publication
(10) Pub. No.: US 2023/0264886 A1
(43) Pub. Date: Aug. 24, 2023

(54) POUCH KIT WITH ATTACHED VIAL

(71) Applicant: Pouch Pac Innovations, LLC, Sarasota, FL (US)

(72) Inventor: R. Charles Murray, Sarasota, FL (US)

(21) Appl. No.: 18/112,039

(22) Filed: Feb. 21, 2023

Related U.S. Application Data
(60) Provisional application No. 63/311,500, filed on Feb. 18, 2022.

(51) Int. Cl. B65D 81/32; B65D 75/58; B65D 75/00; B65D 83/00; B65D 85/72; A23L 2/54; A23L 2/68; A23L 2/56; A23L 33/15; A23L 33/16

(52) U.S. Cl. CPC B65D 81/3272; B65D 75/5883; B65D 75/008; B65D 83/0055; B65D 85/72; A23L 2/54; A23L 2/68; A23L 2/56; A23L 33/15; A23L 33/16; B65D 2575/586

(57) ABSTRACT

A flexible pouch kit that includes a flexible pouch having front and rear panels joined by peripheral seals defining a compartment. A bottom gusset is joined with the front and rear panels. A pair of side gussets are formed and positioned between the bottom gusset and a top peripheral seal of the front and rear panels. The pair of side gussets define an attachment area. A sealable fitment is attached and sealed to the front and rear panels. At least one vial is positioned and removably connected in the attachment area of at least one of the pair of side gussets. The compartment includes a first component and the vial includes a second component different from the first component which is mixed in the compartment after opening of the sealable fitment. A frangible seal may be positioned between the compartment and a top peripheral seal.

### CROSS-REFERENCE TO RELATED APPLICATIONS

This application claims the benefit of U.S. Provisional Application 63/311,500 filed on Feb. 18, 2022, the entire contents of which are incorporated herein by reference.

### FIELD OF THE INVENTION

The application relates to pouch package kits.

### BACKGROUND OF THE INVENTION

Pouch containers may contain various contents such as liquids, powders or solids or other materials. It is often desirable to combine various ingredients after a pouch has been filled with a specific ingredient. There is therefore a need in the art for a pouch kit that may have differing materials that may be combined in a pouch.

### SUMMARY OF THE INVENTION

In one aspect, there is disclosed a flexible pouch kit that includes a flexible pouch having front and rear panels joined by peripheral seals defining a compartment. A bottom gusset is joined with the front and rear panels. A pair of side gussets are formed and positioned between the bottom gusset and a top peripheral seal of the front and rear panels. The pair of side gussets define an attachment area. A sealable fitment is attached and sealed to the front and rear panels. At least one vial is positioned and removably connected in the attachment area of at least one of the pair of side gussets. The compartment includes a first component and the vial includes a second component different from the first component which is mixed in the compartment after opening of the sealable fitment.

In another aspect, there is disclosed a method of consuming hydrogen water including the steps of: providing the flexible pouch kit; filling the pouch with hydrogen water and sealing the pouch; filling the at least one vial with a predetermined amount of magnesium and malic acid and sealing the vial; attaching the vial to the side gusset of the pouch; removing the vial from the side gusset; opening the pouch; opening the vial; placing the contents of the vial into the pouch; shaking the pouch wherein hydrogen is generated from a reaction in the pouch; and consuming a higher hydrogen content hydrogen water.

In a further aspect, there is disclosed a flexible pouch kit that includes a flexible pouch having front and rear panels joined by peripheral seals defining a compartment. A bottom gusset is joined with the front and rear panels. A pair of side gussets are formed and positioned between the bottom gusset and a top peripheral seal of the front and rear panels. The pair of side gussets define an attachment area. A sealable fitment is attached and sealed to the front and rear panels. A frangible seal is positioned between the compartment and a top peripheral seal At least one vial is positioned and removably connected in the attachment area of at least one of the pair of side gussets. The compartment includes a first component and the vial includes a second component different from the first component which is mixed in the compartment after opening of the sealable fitment and breaking of the frangible seal.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a pouch according to one or more embodiments shown and described herein;

FIG. 2 schematically depicts a side view of the pouch of FIG. 1 including an attached vial defining a kit according to one or more embodiments shown and described herein;

FIG. 3 schematically depicts a side view of the pouch of FIG. 1 including an attached vial defining a kit according to one or more embodiments shown and described herein;

FIG. 4 schematically depicts a side view of the pouch of FIG. 1 including an attached vial defining a kit according to one or more embodiments shown and described herein;

FIG. 5 schematically depicts a side view of the pouch of FIG. 1 including an attached vial defining a kit according to one or more embodiments shown and described herein;

FIG. 6 schematically depicts a perspective view of a pouch having a frangible seal according to one or more embodiments shown and described herein.

### DETAILED DESCRIPTION OF THE PREFERRED EMBODIMENTS

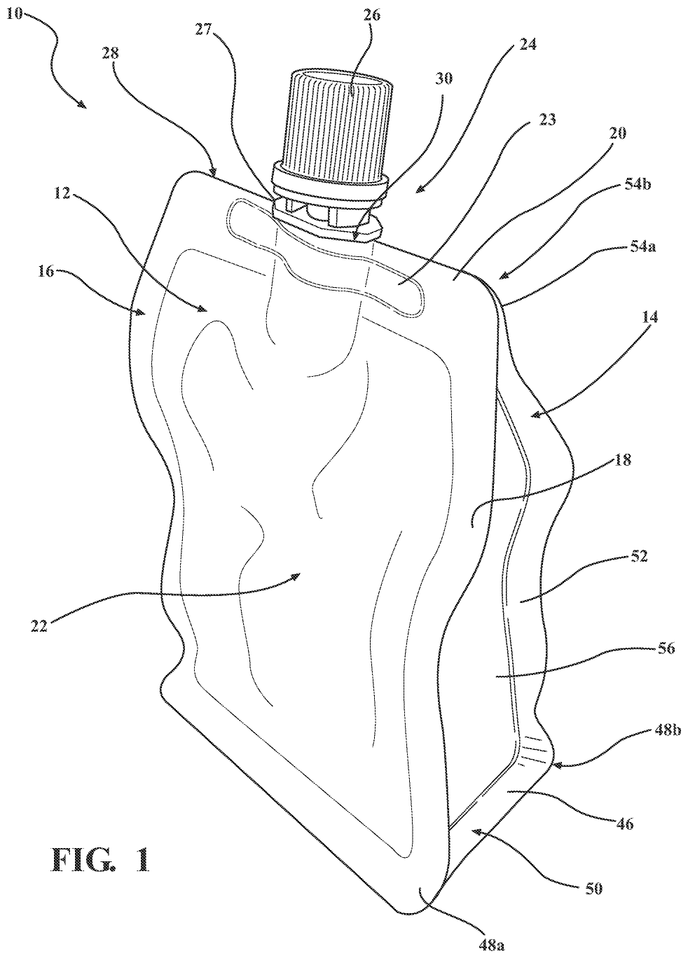

Now referring to FIGS. 1-5, a flexible pouch kit 8 including a flexible pouch 10 is schematically depicted. It should be appreciated that in some embodiments, the flexible pouch 10 may be a stand-up flexible pouch, as depicted in FIGS. 1-5. In other embodiments, the flexible pouch 10 may be any type of pouch that is adapted to contain a fluid. As such, the pouch and kits illustrated in FIGS. 1-5 are non-limiting.

Referring to FIG. 1, the flexible pouch 10 includes a front panel 12 and a rear panel 14. The front panel 12 and the rear panel 14 are sealed to one another via various peripheral seals 16, 18, and 20 to form a compartment 22. That is, the various peripheral seals 16, 18, 20, seal around each peripheral edge of the flexible pouch 10 such that the various peripheral seals 16, 18, 20 permanently bond the front panel 12 and the rear panel 14 to one another to form the compartment 22.

In some embodiments, the various peripheral seals 16, 18, 20 may be a single permanent peripheral seal. Further, in some embodiments, each of the various peripheral seals 16, 18, 20 may be formed by heat sealing. In other embodiments, the various peripheral seals 16, 18, 20 are formed by other methods appreciated by those skilled in the art. The compartment 22 may be adapted to contain, or hold, a gas, solid and/or liquid. For example, the compartment 22 may be adapted to contain, or hold a fluid, such as hydrogenated water.

A sealable fitment 24 with a body is provided along an upper edge 28 of the flexible pouch 10. In some embodiments, the fitment 24 may be centered along the upper edge 28. In other embodiments, the fitment 24 may be positioned anywhere along the upper edge 28 of the flexible pouch 10. The fitment 24 includes a center portion 30, or passage. The center portion 30 includes an opening (not shown) at one end and a spout 27 at the other end. The opening is positioned within the flexible pouch 10 while the spout 27 is at the opposite end of the body and out of the flexible pouch 10. The center portion 30 extends within a gap of the peripheral seal 20 along the upper edge 28. The fitment 24, the front and rear panels 12, 14 are sealed together via a top seal 23. The top seal 23 seals the front and rear panels 12, 14 together and the fitment 24 therebetween thereby eliminating the gap. In some embodiments, the top seal 23 is formed via ultrasonic welding techniques. In other embodiments, the top seal 23 is formed via traditional heat bonding methods.

The front and rear panels 12, 14 are formed from a film laminate including a layer of aluminum or silicon oxide. The film laminate, in some embodiments, may be PET/AL/NY/LLDPE; PETALOx/NY/LLDPE; or PETSiOx/NY/LLDPE. Further, varying thickness of the film may be used. For example, a PET film layer may have a thickness of 12 microns, a center aluminum layer having a thickness of 9 microns and an inner layer of S-LLDPE that has a thickness of 150 microns may be used. Such an arrangement provides an airtight seal to preserve the longevity of the fluid within the compartment 22. Further, the outer layer of PET may be satisfactory for printing labeling information and warning information, the middle aluminum layer may provide an airtight seal for the flexible pouch 10, and the inner layer of S-LLDPE may melt to form an adhesive for bonding the front and rear panels 12, 14 of the flexible pouch together around the peripheral seals 16, 18, 20, to seal the fitment 24 or closures in place. Further, it should be understood that film laminates provide or inherently include barrier properties.

The film laminate may be formed into a pouch having three sides on a conventional pouch making machine. The fitment may be heat sealed or ultra-sonically welded along the upper edge 28 of the flexible pouch 10 to form the top seal 23. The flexible pouch 10 is then filled with the fluid into the compartment 22 and the cap 26 is secured onto the fitment to seal the center portion 30 and the spout 27.

The opening and the spout 27 are covered by a cap 26 when the cap 26 is secured onto the body of the fitment 24. The cap 26 is removable to provide access to the spout 27 and the opening, which in turn provides access to the contents of the compartment 22. In some embodiments, the cap 26 may be provided with a childproof or tamperproof feature to prevent ready access to or tampering of the product. The center portion 30 of the fitment 24 extends through the top seal 23 and is adapted as an entry and/or exit for the gas, solid and/or liquid held in the compartment 22 of the flexible pouch 10.

In embodiments, a bottom gusset 46 may positioned between a bottom edge portion 48a of the front panel 12 and a bottom edge portion 48b of the rear panel 14 such that a stable base for the flexible pouch 10 is provided. That is, the bottom gusset 46 may be attached to the bottom edge portions 48a, 48b with a bottom portion 50 sealed to the bottom edge portions 48a, 48b such that the flexible pouch 10 can stand or remain upright.

Further, a pair of side gussets 52 may be formed and positioned between the bottom gusset 48 and the top seal 23. Each of the pair of side gussets 52 may be positioned between an upper edge portion 54a and the bottom edge portion 48a of the front panel 12 and an upper edge portion 54b and the bottom edge portion 48b of the rear panel 14. That is, a side panel 56 of each of the pair of side gussets 52 may be attached to the upper edge portion 54a and the bottom edge portion 48a of the front panel 12 and the upper edge portion 54b and the bottom edge portion 48b of the rear panel 14.

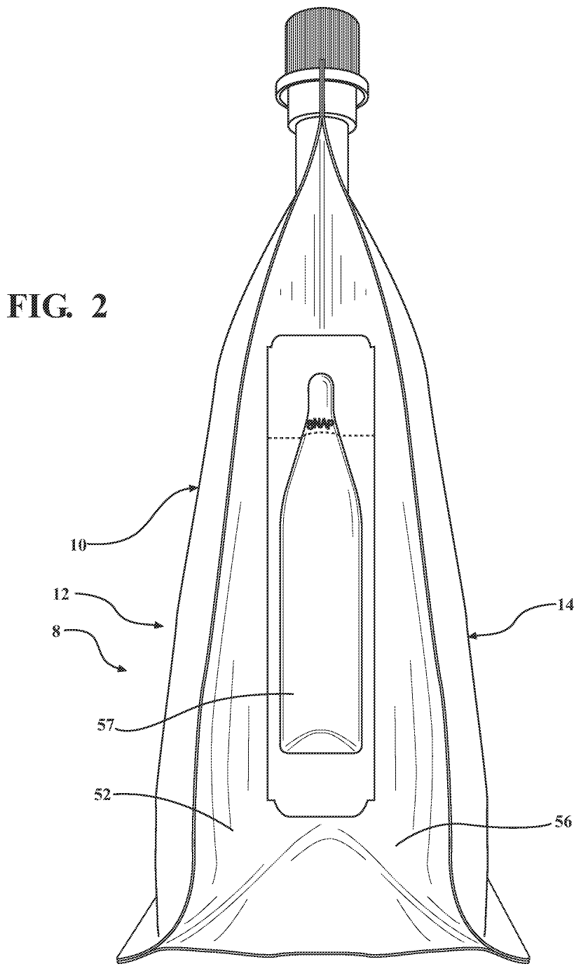

Referring to FIGS. 2-5, in one aspect, a vial 57 may be positioned within an attachment area defined by the side gusset 52. The vial 57 may be removably connected to the side panel 56 by an adhesive to define the kit 8. The kit 8 includes the pouch 10 and a vial 57. The vial 57 may contain an additional ingredient that may be added to the contents of the pouch 10. For example, the pouch may contain a liquid product such as hydrogenated water and the vial 57 may contain a flavoring, supplement such as a vitamin, CBD or other compound that may be added to water. The flavoring may be a fruit juice or other agent. The vial 57 may contain a liquid, powder or a tablet that may be added to the contents of the pouch.

In one aspect, the pouch 10 may contain a hydrogenated water having a hydrogen content of from 1.5 to 5 ppm. The vial 57 may contain a specified or predefined amount of magnesium, such as around 80 mg in a tablet or powder form. The magnesium may be added to the hydrogen water to increase a hydrogen content of the water in the pouch 10. In one aspect, an additional component such as an acid may be also be in the vial 57 or in a separate vial 57. For example, malic acid (C₄H₆O₅) and/or tartaric acid (C₄H₆O₆) may be included in a vial 57. The amount of acid present is approximately 10% by weight of the magnesium weight.

The kit 8 allows for a separate component contained in the vial 57 to be added to the material contained in the pouch 10 after the pouch 10 has been opened to access the contents of the pouch 10. In one aspect, the vial 57 is completely contained or disposed in the side gusset 52 of the pouch 10 to securely provide a kit 8 that is easily packaged as a unit.

Various sized and shaped vials may be contained in the side gusset 52 of the pouch. Sizes of vials 56 may range from 1 to 15 ml when used with a 350 ml pouch 10. It should be realized that various sized pouches 10 and vials 57 may be utilized.

As shown in FIG. 2, a 2.5 ml vial 57 may be positioned in the side gusset 52 of the pouch 10 and is attached to the side panel 56.

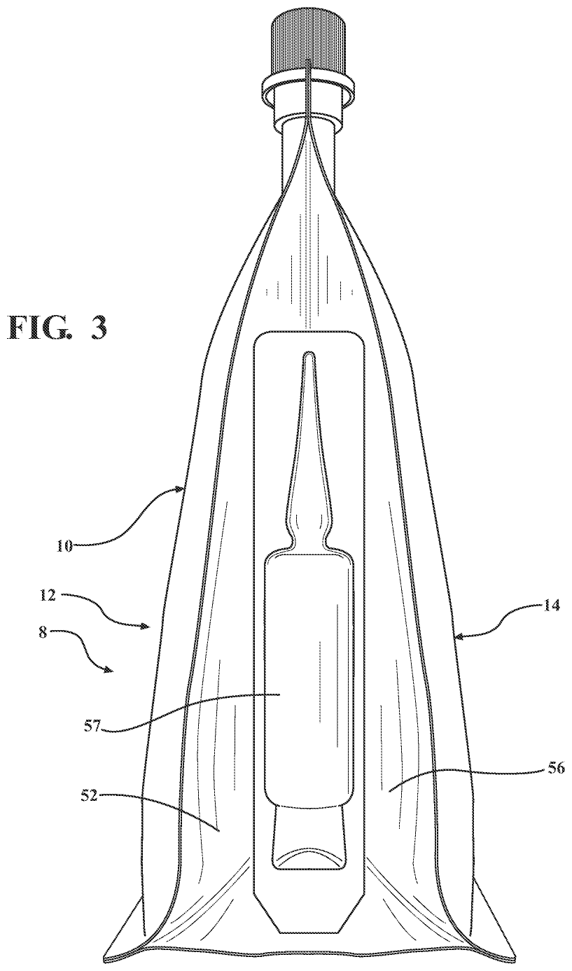

As shown in FIG. 3, a 5 ml vial 57 may be positioned in the side gusset 52 of the pouch 10 and is attached to the side panel 56.

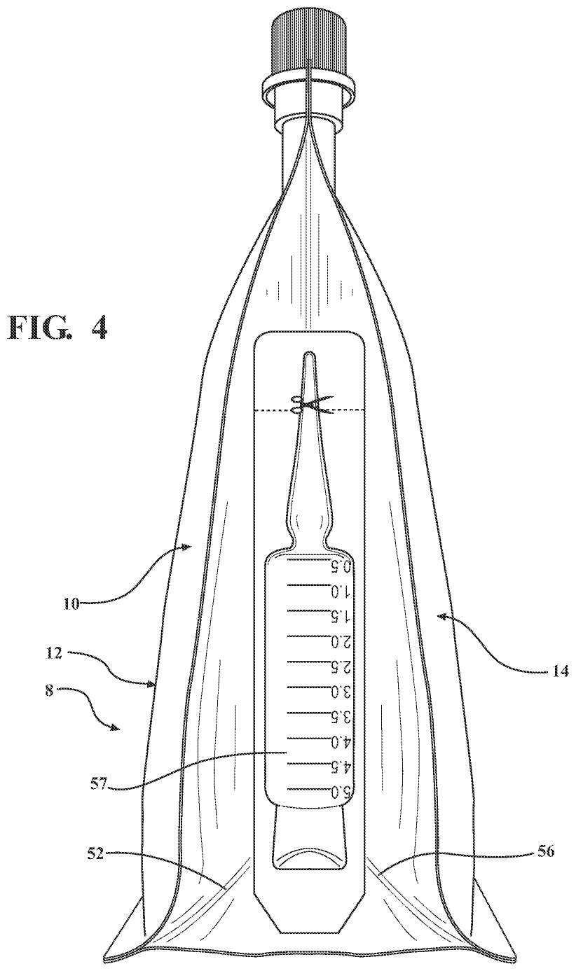

As shown in FIG. 4, a child proof 5 ml vial 57 may be positioned in the side gusset 52 of the pouch 10 and is attached to the side panel 56. The child proof vial may require the use of scissors to open the vial.

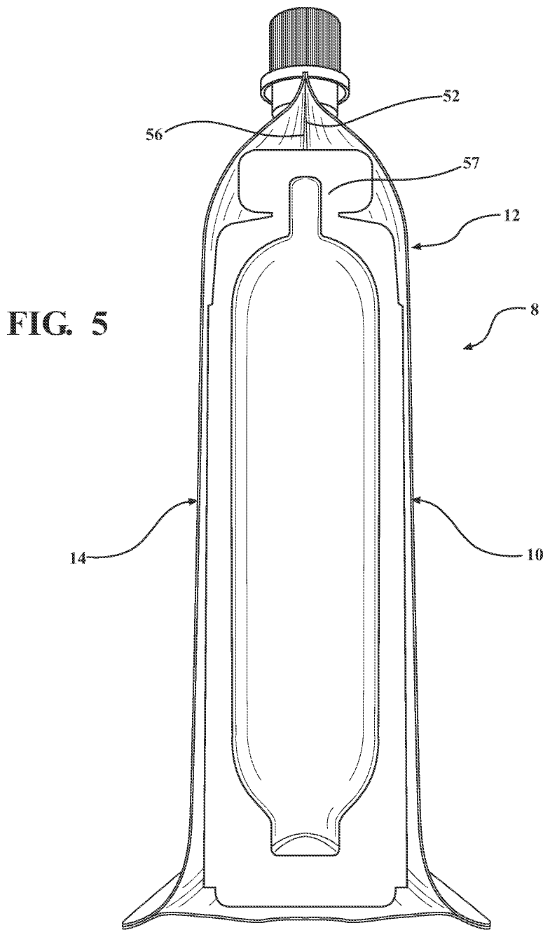

As shown in FIG. 5, a 15 ml vial 57 may be positioned in the side gusset 52 of the pouch 10 and is attached to the side panel 56.

In one aspect, the vials 57 may be positioned in one of the side gussets 52 or alternatively in both of the side gussets 52. Different sized vials 57 may be positioned in each of the side gussets 52 or the vials 57 may have the same size. The vials 57 may contain the same or different materials that may be added to the contents of the pouch 10 at the same time or at varying times.

In use, a person may remove the vial or vials 57 from the side gussets 52 of the pouch 10. Next, the cap 26 may be removed from the pouch 10. The vial or vials 57 may be opened and the contents of the vial or vials 57 may be combined with the contents of the pouch 10.

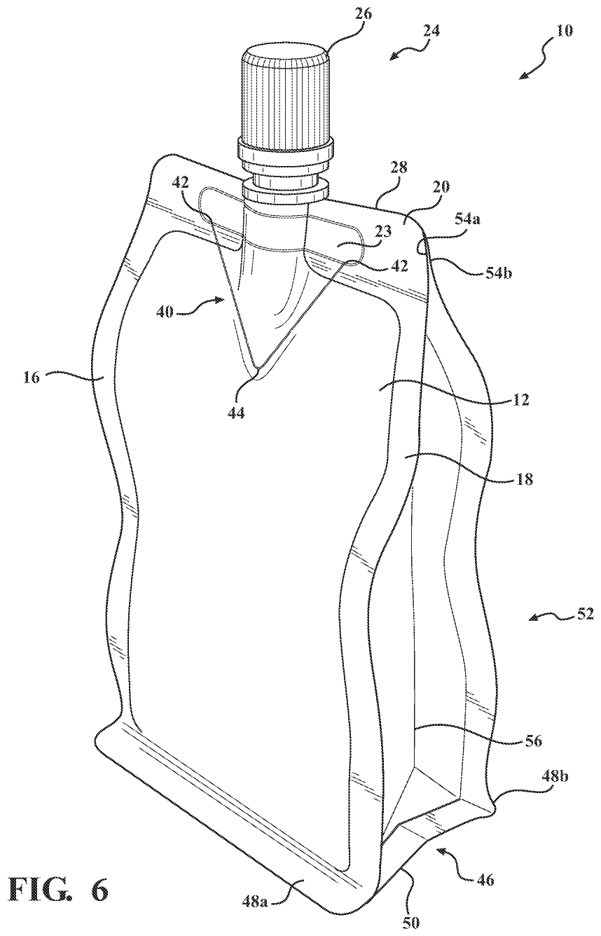

Referring to FIG. 6, in one aspect, the pouch may include a frangible seal. A frangible seal 40 is positioned between the compartment 22 and the top seal 23. As such, in some embodiments, a portion of the frangible seal 40 abuts the top seal 23 and a portion of the frangible seal 40 extends into the compartment 22. In other embodiments, a portion of the frangible seal 40 extends into the top seal 23. The frangible seal 40 joins the front and rear panels 12, 14 and is adapted, in an unbroken state, to prevent hydrogen from the liquid held within the compartment 22 to escape through the center portion 30 and ultimately through the cap 26. When the user wants to drink the fluid held within the compartment 22, the frangible seal 40 is broken, or ruptured, by squeezing or applying a predetermined pressure onto the flexible pouch 10 to break or rupture the frangible seal 40.

In some embodiments, the frangible seal 40 is a V-shape. In this embodiment, each of a pair of terminating ends 42 of the V-shape are positioned to abut the top seal 23 and an inverse apex 44 of the V-shape is positioned within the compartment 22. In other embodiments, the frangible seal 40 may be square shaped, semicircular shaped, rectangular shape, and the like. In these embodiments, the terminating ends of the different shapes are positioned within or to abut the top seal 23 and portions of the shape are positioned within the compartment 22. The frangible seal and method of forming the frangible seal are described in U.S. application Ser. No. 17/365,711 filed on Jul. 1, 2021 and is herein incorporated by reference in its entirety.

Also disclosed herein is a method of consuming hydrogen water in a kit. The method includes the steps of: providing a flexible pouch having hydrogen water disposed within the pouch compartment and sealing the pouch, providing a vial including magnesium and an acid and sealing the vial; attaching the vial to a side gusset of the flexible pouch, removing the vial from the side gusset, opening the pouch and opening the vial and placing the contents of the vial into the pouch, shaking the pouch wherein hydrogen is generated from a reaction in the pouch and consuming an higher or elevated hydrogen content hydrogen water.

### Example 1

A 350 ml pouch having the structure including the frangible seal as described above, containing hydrogen water having a hydrogen content of 1.5 ppm is provided. A vial is positioned in the side gusset as described above and is attached to the side panel. The vial contains 80 mg of magnesium metal and 8 mg of malic acid.

The vial is removed from the side gusset and the frangible seal is ruptured and the cap was removed from the pouch. The vial is opened and the contents are poured into the pouch. The pouch is shaken for approximately 90 seconds and the magnesium and malic acid react with water to generate hydrogen gas. The hydrogen gas is retained in the water to raise the hydrogen content of the water to 4 ppm. The contents of the pouch are immediately consumed to maintain the higher hydrogen content.

1. A flexible pouch kit comprising:
a flexible pouch having front and rear panels joined by peripheral seals defining a compartment;
a bottom gusset joined with the front and rear panels;
a pair of side gussets formed and positioned between the bottom gusset and a top peripheral seal of the front and rear panels, the pair of side gussets defining an attachment area;
a sealable fitment attached and sealed to the front and rear panels;
at least one vial positioned and removably connected in the attachment area of at least one of the pair of side gussets;
wherein the compartment includes a first component and the vial includes a second component different from the first component which is mixed in the compartment after opening of the sealable fitment.

2. The flexible pouch kit of claim 1 wherein the at least one vial is completely disposed within the at least one side gusset.

3. The flexible pouch kit of claim 1 wherein the at least one vial is a 2.5 ml sized vial.

4. The flexible pouch kit of claim 1 wherein the at least one vial is a 5 ml sized vial.

5. The flexible pouch kit of claim 1 wherein the at least one vial is a 5 ml child proof sized vial.

6. The flexible pouch kit of claim 1 wherein the at least one vial is a 15 ml sized vial.

7. The flexible pouch kit of claim 1 wherein the at least one vial includes a predefined amount of magnesium and the compartment includes hydrogen water.

8. The flexible pouch kit of claim 7 wherein the hydrogen water has a hydrogen content of 1.5 ppm and the amount of magnesium is 80 mg.

9. The flexible pouch kit of claim 7 wherein the at least one vial further includes an acid in an amount of 10% of the magnesium content.

10. The flexible pouch kit of claim 9 wherein the acid is selected from malic acid and tartaric acid.

11. The flexible pouch kit of claim 1 wherein the pouch further includes a frangible seal positioned between the compartment and a top peripheral seal.

12. The flexible pouch kit of claim 1 including two vials positioned in each of the side gussets.

13. The flexible pouch kit of claim 1 wherein the vial includes a flavoring agent.

14. The flexible pouch kit of claim 1 wherein the vial includes a vitamin supplement.

15. The flexible pouch kit of claim 1 wherein the vial includes CBD.

16. A method of consuming hydrogen water of claim 1 including the steps of:
providing the flexible pouch kit of claim 1;
filling the pouch with hydrogen water and sealing the pouch;
filling the at least one vial with a predetermined amount of magnesium and malic acid and sealing the vial;
attaching the vial to the side gusset of the pouch;
removing the vial from the side gusset;
opening the pouch;
opening the vial;
placing the contents of the vial into the pouch;
shaking the pouch wherein hydrogen is generated from a reaction in the pouch; and
consuming a higher hydrogen content hydrogen water.

17. The method of claim 16 wherein the hydrogen water in the filled pouch has a hydrogen content of 1.5 ppm and the vial has 80 mg of magnesium and 8 mg of malic acid and wherein after shaking the water consumed has a hydrogen content of 4 ppm.

18. The method of claim 16 wherein the pouch further includes a frangible seal positioned between the compartment and a top peripheral seal and wherein the step of opening the pouch includes breaking the frangible seal.

19. A flexible pouch kit comprising:
a flexible pouch having front and rear panels joined by peripheral seals defining a compartment;
a bottom gusset joined with the front and rear panels;
a pair of side gussets formed and positioned between the bottom gusset and a top peripheral seal of the front and rear panels, the pair of side gussets defining an attachment area;
a sealable fitment attached and sealed to the front and rear panels;
a frangible seal positioned between the compartment and a top peripheral seal;
at least one vial positioned and removably connected in the attachment area of at least one of the pair of side gussets;
wherein the compartment includes a first component and the vial includes a second component different from the first component which is mixed in the compartment after opening of the sealable fitment and breaking of the frangible seal.
